(19) United States
(12) Patent Application Publication
(10) Pub. No.: US 2008/0158360 A1
(43) Pub. Date: Jul. 3, 2008

(54) VISION ASSIST APPARATUS

(75) Inventors: Kenji KATOU, Nishikamo-gun (JP); Satoshi TAKEHISA, Nagoya-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/957,570

(22) Filed: Dec. 17, 2007

(30) Foreign Application Priority Data
Dec. 28, 2006 (JP) 2006-355969

(51) Int. Cl. H04N 7/18

(52) U.S. Cl. 348/148; 348/E07.085

(57) ABSTRACT

A vision assist apparatus for assisting a vision of a driver in a vehicle having a headlight includes a night vision camera, a display device, detecting unit, a lighting controlling unit, and a display controlling unit. The night vision camera is configured to capture an image around the vehicle. The display device is configured to display the image captured by the night vision camera. The detecting unit is configured to detect an object that exists in front of the vehicle. The lighting controlling unit controls that the headlight the vehicle. The lighting controlling unit operates the headlight in a high beam mode when the detecting unit does not detect the object while the headlight is on. The display controlling unit causes the display device to display the image captured by the night vision camera when the object exists in front of the vehicle.

### CROSS REFERENCE TO RELATED APPLICATION

This application is based on and incorporates herein by reference Japanese Patent Application No. 2006-355969 filed on Dec. 28, 2006.

### BACKGROUND OF THE INVENTION

1. Field of the Invention

The present invention relates to a vision assist apparatus that assists a vision of a driver in a vehicle.

2. Description of Related Art

Conventionally, JP-A-2000-198385 describes an example of a conventional apparatus for assisting a vision of a driver in a vehicle.

In the apparatus described in JP-A-2000-198385, an optical axis of a headlight of the vehicle is adjustable in up, down, right, and left directions, and a light quantity of the headlight is also adjustable. When it is detected that an opposed vehicle is approaching, the optical axis and the light quantity are arranged or made in a reference position and in a reference quantity, respectively. However, when the opposed vehicle is not detected to be approaching, the optical axis is lead in the upper direction, and the light quantity is increased.

As described above, in JP-A-2000-198385, when the opposed vehicle is not detected to be approaching, the optical axis is lead in the upper direction and the light quantity is increased. Thus, the vision of the driver is assisted. However, when the opposed vehicle is detected to be approaching, the optical axis and the light quantity are each made in the reference conditions, and therefore, the vision is not sufficiently assisted.

### SUMMARY OF THE INVENTION

The present invention is made in view of the above disadvantages. Thus, it is an objective of the present invention to address at least one of the above disadvantages.

To achieve the objective of the present invention, there is provided a vision assist apparatus for assisting a vision of a driver in a vehicle having a headlight, the apparatus comprising a night vision camera, a display device, detecting unit, a lighting controlling unit, and a display controlling unit. The night vision camera is configured to capture an image around the vehicle. The display device is configured to display the image captured by the night vision camera. The detecting unit is configured to detect an object that exists in front of the vehicle. The lighting controlling unit controls that the headlight of the vehicle. The lighting controlling unit turns on the headlight when a certain condition is satisfied. The lighting controlling unit operates the headlight in a low beam mode when the detecting unit detects the object while the headlight is on. The lighting controlling unit operates the headlight in a high beam mode when the detecting unit does not detect the object while the headlight is on. The display controlling unit causes the display device to display the image captured by the night vision camera when the object exists in front of the vehicle.

### BRIEF DESCRIPTION OF THE DRAWINGS

The invention, together with additional objectives, features and advantages thereof will be best understood from the following description, the appended claims and the accompanying drawings in which:

FIG. 1 is a block diagram showing a schematic configuration of a vision assist apparatus according to an embodiment of the present invention;

FIG. 2 is a flow chart showing a process operation of the vision assist apparatus according to the embodiment of the present invention;

FIG. 3 is a conceptual drawing showing an appearance of a vehicle having the vision assist apparatus during a high-beam operation according to the embodiment of the present invention;

FIG. 4 is a conceptual drawing showing an external view of a windshield of the vehicle having the vision assist apparatus during the high-beam operation according to the embodiment of the present invention;

FIG. 5 is a conceptual drawing showing an appearance of the vehicle having the vision assist apparatus during a low beam mode according to the embodiment of the present invention; and

FIG. 6 is a conceptual drawing showing an external view of the windshield of the vehicle having the vision assist apparatus during the low beam mode according to the embodiment of the present invention.

### DETAILED DESCRIPTION OF PREFERRED EMBODIMENTS

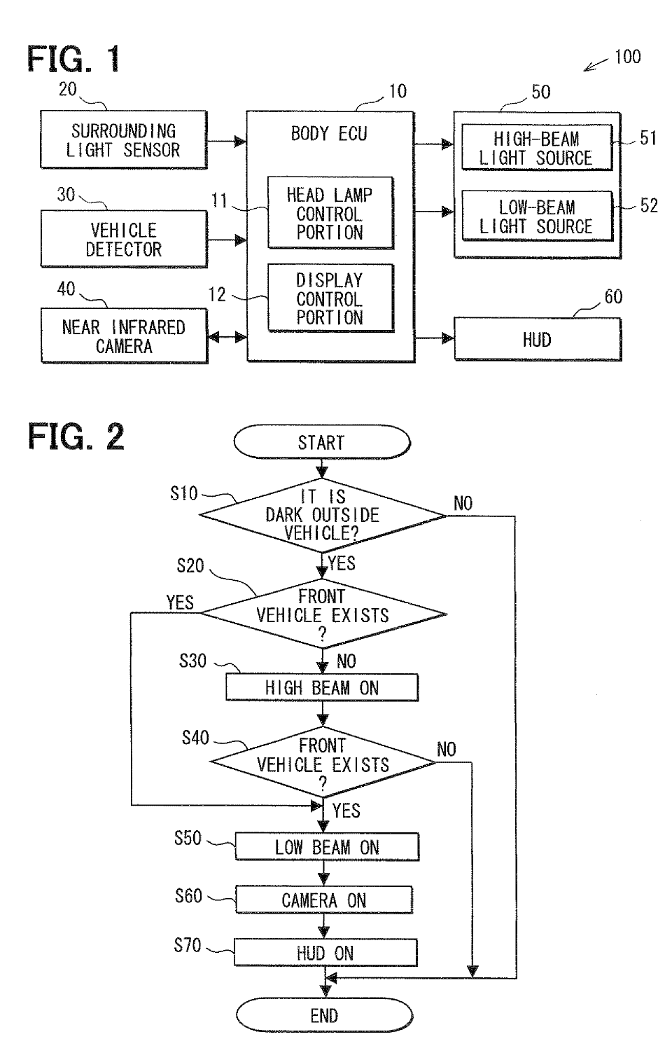

One embodiment of the present invention is described referring to accompanying drawings. FIG. 1 is a block diagram showing a schematic configuration of a vision assist apparatus according to the one embodiment of the present invention.

The vision assist apparatus of the present embodiment is designed to be mounted on a vehicle, and assists a vision of a driver in the vehicle, specially when an ambient environment is dark (e.g., at night). As shown in FIG. 1, the vision assist apparatus includes a body ECU (electronic control unit) 10, a surrounding light sensor 20, a vehicle detector 30, a near infrared camera 40, a headlamp 50, and an HUD (head up display) 60, all of which are electrically connected with the body ECU 10.

The body ECU 10 includes a CPU, a ROM, a RAM, an input/output circuit, a headlamp control portion 11, and a display control portion 12. The CPU serves as a central processing unit that executes well-known various computation processes. The ROM stores control programs, and the RAM stores various data sets. The headlamp control portion 11 controls the headlamp 5, and the display control portion 12 controls the HUD 60.

Specifically, the headlamp control portion 11 (lighting controlling unit) of the body ECU 10 turns on the headlamp 50 in accordance with a detection result of the surrounding light sensor 20, and changes an operation of the headlamp 50 between a high beam mode and a low beam mode in accordance with a detection result of the vehicle detector 30. Also, when the headlamp 50 is operated in the low beam mode, the display control portion 12 (display controlling unit) of the body ECU 10 causes the HUD 60 to display an image that is taken by the near infrared camera 40.

The surrounding light sensor 20 includes a illuminance sensor that senses luminosity of a surrounding of an own vehicle M1, on which the surrounding light sensor 20 is mounted, and outputs a detection result to the body ECU 10.

The vehicle detector 30 corresponds to a detecting unit of the present invention, and includes a CMOS image sensor. The vehicle detector 30 detects a preceding vehicle that travels ahead of (in front of) the own vehicle M1 in the same direction with the own vehicle M1. Typically, the vehicle detector 30 detects the vehicle that travels ahead of the own vehicle M1 in the same traffic lane, in which the own vehicle M1 travels. Also, the vehicle detector 30 detects an opposed vehicle that travels to approach the own vehicle M1 from ahead of (a front side of) the own vehicle M1. Typically, the vehicle detector 30 detects the vehicle that travels from a position in front of the own vehicle M1 toward the own vehicle M1 in an opposite traffic lane opposite the traffic lane, in which the own vehicle M1 travels. That is, the vehicle detector 30 detects a tail lamp of the preceding vehicle, or a headlamp of the opposed vehicle based on the image taken by the CMOS image sensor. Note that, both the preceding vehicle and the opposed vehicle may be indicated as a front vehicle M2. Also, the vehicle detector 30 is not limited to the CMOS image sensor, however, the vehicle detector 30 may detect the front vehicle M2 using a millimeter wave radar or a laser radar to achieve the objective of the present invention.

The near infrared camera 40 corresponds to a night vision camera of the present invention, and includes a floodlight and an imaging element. The floodlight applies light having a wavelength of a near infrared range to a predetermined area ahead of the own vehicle M1. The imaging element may be a CCD or CMOS that is sensitive around the near infrared range. Note that, a far infrared camera can be employed as the night vision camera to achieve the objective of the present invention instead of the near infrared camera 40 of the present embodiment. Although, the far infrared camera captures an image of a heat emitting object, the near infrared camera 40 is not limited to capturing the image of the heat emitting object. As a result, the near infrared camera 40 is more preferable as the night vision camera used for vision assist apparatus.

The headlamp 50 has a four-lamp system and indicates one of the right and left headlamps in the present embodiment. The headlamp 50 includes a high-beam light source 51, a low-beam light source 52, and a reflector (not shown). In other words, the headlamp 50 is arranged on each of the right and left sides of a vehicle front part and includes two lighting fittings. One of the lighting fittings that is positioned inwardly relative to the other one in a transverse direction of the vehicle receives the high-beam light source 51, and the other one of the lighting fittings that is positioned outwardly relative to the one in the transverse direction receives the low-beam light source 52. Also, the headlamp 50 is configured to be driven (turned on and off) in accordance with a signal from the body ECU 10. Further, the operation of the headlamp 50 is changed between the high beam mode and the low beam mode in accordance with the signal from the body ECU 10. Specifically, when in the low beam mode, the low-beam light source 52 is on exclusively and the high-beam light source 51 is off such that the light is downwardly projected in the area vicinity of the own vehicle M1. In contrast, when in the high beam mode, the low-beam light source 52 is kept on and the high-beam light source 51 is also on such that the light is projected to the area further away from the own vehicle M1. Note that, the headlamp 50 is not limited to the headlamp of the four-lamp system, however, the headlamp 50 may have a two-lamp system. Also, reflector may be actuated to change the direction of projecting (applying) the light.

The HUD (head up display) 60 includes a light application device and a combiner 61. The light application device employs a cathode-ray tube (CRT), a liquid crystal display, or a vacuum fluorescent display mounted in an instrument panel (e.g., dashboard). The combiner 61 is provided between a windshield and a driver of the vehicle and reflects information applied by the light application device toward the driver. The combiner 61 includes a translucent reflector, and provides a superimposed vision, in which the information applied by the light application device is superimposed onto a view outside. Because this enables the driver to see an image ahead of the vehicle at night as a virtual image, the vision of the driver at night can be assisted for safety drive. Note that, the information applied by the light application device may be projected (applied) to a part of the windshield that corresponds to the field of the vision of the driver, if the information applied by the light application device can be sufficiently reflected toward the driver.

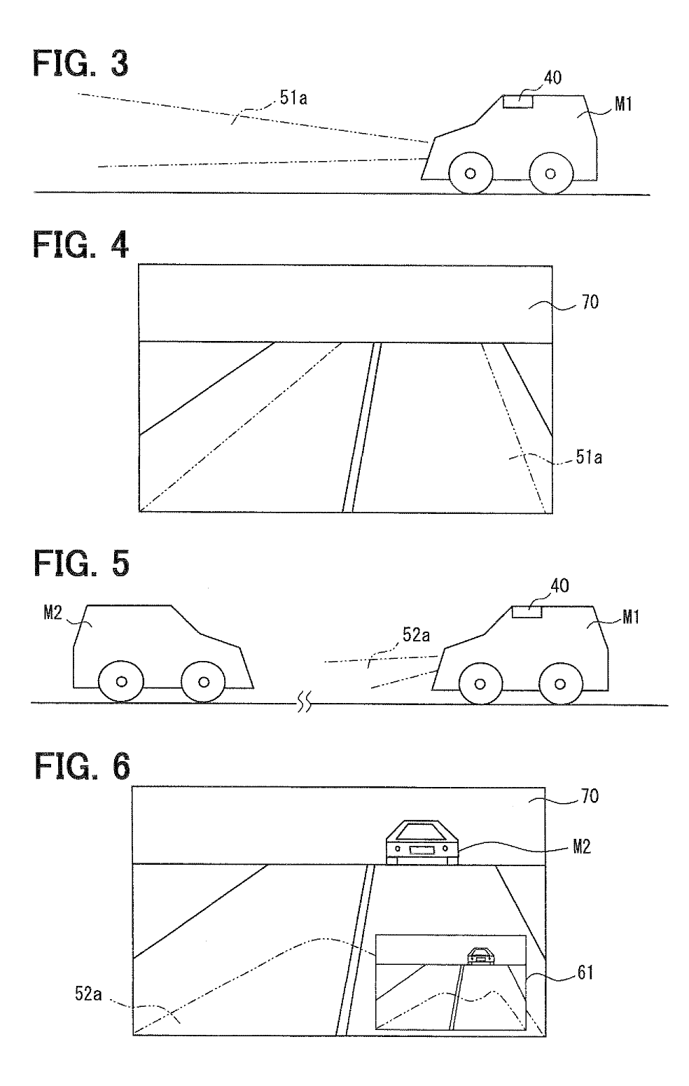

A process operation of the above vision assist apparatus of the present embodiment is described. FIG. 2 is a flow chart showing the process operation of the vision assist apparatus according to the embodiment of the present invention. FIG. 3 is a conceptual drawing showing an appearance of the vehicle having the above vision assist apparatus during the high-beam operation. FIG. 4 is a conceptual drawing showing an external view of the windshield of the vehicle having the above vision assist apparatus during the high-beam operation. FIG. 5 is a conceptual drawing showing an appearance of the vehicle having the above vision assist apparatus during the low beam mode. FIG. 6 is a conceptual drawing showing an external view of the windshield of the vehicle having the above vision assist apparatus during the low beam mode. Note that the process shown in FIG. 2 is repeatedly executed every predetermined interval.

Firstly, at step S10, the body ECU 10 (the headlamp control portion 11) determines whether or not it is dark outside the vehicle based on a detection result of the surrounding light sensor 20 in order to determine whether or not the headlamp 50 is to be turned on. When the detection result (e.g., the luminosity of the surrounding of the vehicle) of the surrounding light sensor 20 indicates equal to or less than a certain value, the body ECU 10 determines that the headlamp 50 is required to be turned on because the time may indicate night time or because the own vehicle M1 is located in a dark place, As a result, the driver is advantageously limited from turning on the headlamp 50 and thereby saving a labor of the driver. Thus, control proceeds to step S20. However, when the detection result (the luminosity of the surrounding of the vehicle) of the surrounding light sensor 20 indicates greater than the certain value, the body ECU 10 determines that the headlamp 50 is not required to be turned on, and the process is ended.

At step S20, the body ECU 10 (the headlamp control portion 11) determines whether the front vehicle M2 exits in front of (ahead of) the own vehicle M1 based on a detection result of the vehicle detector 30 in order to determine whether the headlamp 50 is operated in either in the high beam mode (high beam ON) or in the low beam mode (low beam ON). When the body ECU 10 determines that the front vehicle M2 exists, control proceeds to step S50, and when the body ECU 10 determines that the front vehicle M2 does not exist, control proceeds to step S30.

At step S30, the body ECU 10 (the headlamp control portion 11) turns on the headlamp 50, and turns on the high-beam light source 51 and the low-beam light source 52 to operated the headlamp 50 in the high beam mode (high beam ON) as shown in FIG. 3, because the front vehicle M2 does not exist and thereby there is no possibility of providing discomfort glare to an occupant of the front vehicle M2. As a result, the headlamp 50 during the high-beam operation has a light application area 51a (area applied with the light) that covers an area far way from the vehicle as shown in FIG. 4. Therefore, the vision of the driver of the vehicle M1 during a travel at night or at a dark area can be sufficiently assisted. Also, this significantly improves the safety of the driving at night or at the dark area.

Also, the front vehicle M2 may appear while the vehicle M1 travels in a state, where the headlamp 50 is operated in the high beam mode. Thus, at step S40, the body ECU 10 (the headlamp control portion 11) determines whether the front vehicle M2 exists based on the detection result of the vehicle detector 30 in order to determine whether the operation of the headlamp 50 is to be operated in the high beam mode or to be changed from the high beam mode to the low beam mode. Then, when it is determined that the front vehicle M2 exists, control proceeds to step S50, but when it is determined that the front vehicle M2 does not exist, the process is ended.

At step S50, the body ECU 10 (the headlamp control portion 11) turns off the high-beam light source 51, and turns on only the low-beam light source 52 to operate the headlamp 50 in the low beam mode (low beam ON) for a state, where the headlamp 50 is on, as shown in FIG. 5 because the front vehicle M2 exists, and thereby there is a risk (possibility) of giving the discomfort glare to the occupant of the front vehicle M2.

However, when the headlamp 50 is operated in the low beam mode, the headlamp 50 comes to have a light application area 52a (area applied with the light) that covers only a vicinity of the own vehicle M1. As a result, the vision of the driver of the own vehicle M1 may not be sufficiently assisted. In other words, the driver of the own vehicle M1 may become having a difficulty in visually recognizing (seeing) the front vehicle M2.

Thus, in the present embodiment, at step S60, the body ECU 10 (the display control portion 12) causes the near infrared camera 40 to capture images (camera ON) in response to the execution by the headlamp control portion 11 to operate the headlamp 50 in the low beam mode.

Further, at step S70, the body ECU 10 (the display control portion 12) causes the image captured by the near infrared camera 40 to be displayed in the combiner 61 (HUD ON) as shown in FIG. 6 in response to the execution by the headlamp control portion 11 to operate the headlamp 50 in the low beam mode.

As a result, it is limited from giving the discomfort glare to the occupant of the front vehicle M2, and at the same time, the vision of the driver of the own vehicle M1 can be assisted.

That is, when the front vehicle M2 does not exist in front of the own vehicle M1, the headlamp 50 is operated in the high beam mode. When the front vehicle M2 exists in front of the own vehicle M1, the image captured by the near infrared camera 40 is displayed in the combiner 61 in addition to operating the headlamp 50 in the low beam mode. Thereby, the vision can be always assisted appropriately.

In other words, in an comparative example case, where the operation of the headlamp 50 is changed between the high beam mode and the low beam mode in accordance with the existence of the front vehicle M2, if the front vehicle M2 does not exist in front of the own vehicle M1, the vision can be sufficiently assisted by applying the light to the position (area) far away from the own vehicle M1 through the high beam mode. However, in contrast, if the front vehicle M2 exists in front of the own vehicle M1 in the above comparative example case, the vision cannot be sufficiently assisted because the light disadvantageously cannot be applied to the position far away during the low beam mode. However, in the configuration of the present embodiment, the disadvantages of the assisting the vision can be limited and the vision can be always assisted appropriately.

Also, in the present embodiment, the HUD 60 is employed as a display device for displaying the image captured by the near infrared camera 40 in the position in the windshield of the own vehicle M1 correspondingly to the driver, or for applying and displaying the image in the combiner 61 that is provided between the windshield and the driver. Thus, movement of the sightline of the driver can be reduced advantageously.

In the present embodiment, the body ECU 10 (the display control portion 12) is described to cause the HUD 60 to display the image captured by the near infrared camera 40 when the headlamp control portion 11 operates the headlamp 50 in the low beam mode. However, the present invention is not limited to the above. For example, the body ECU 10 (the display control portion 12) may cause the HUD 60 to display the image captured by the near infrared camera 40 alternatively when the vehicle detector 30 detects the front vehicle M2.

Also, in the present embodiment, the image captured by the near infrared camera 40 is described to be displayed by using the HUD 60, However, the present invention is not limited to the above. For example, the image captured by the near infrared camera 40 may be alternatively displayed in an other-purposed display, such as a navigation device display or a vehicle TV display.

Also, in the present embodiment, the surrounding light sensor 20 is used for determining whether or not the headlamp 50 is to be turned on. However, the present invention is not limited to the above. For example, there may be provided an operation device (operation unit) that is operated by a user (e.g., a driver, an occupant of the vehicle) and that outputs an operation signal indicative of turning on or off of the headlamp 50. Then, the body ECU 10 (the headlamp control portion 11) may turn on the headlamp 50 when the operation signal indicative of the turning on is outputted.

Also, in the present embodiment, the detecting unit of the present invention is described to detect the front vehicle M2 (the preceding vehicle, the opposed vehicle). However, the present invention is not limited to the above. For example, instead of the vehicle detector 30, the near infrared camera 40 may be used to detect a person or a parking vehicle that exists in front of the own vehicle M1 by image processing the image captured by the near infrared camera 40. That is, an object that exists in front of the own vehicle M1 is not limited to the preceding vehicle or the opposed vehicle. However, the object may be a person and/or a parking vehicle that exists in front of the own vehicle M1. In other words, the object that exists in front of the own vehicle M1 may be at least one of a person and another vehicle that exists in front of the own vehicle M1. As a result, the headlamp 50 can be appropriately changed between the high beam mode and the low beam mode.

Additional advantages and modifications will readily occur to those skilled in the art. The invention in its broader terms is therefore not limited to the specific details, representative apparatus, and illustrative examples shown and described.

What is claimed is:

1. A vision assist apparatus for assisting a vision of a driver in a vehicle having a headlight, the apparatus comprising:
a night vision camera that is configured to capture an image around the vehicle;
a display device that is configured to display the image captured by the night vision camera;
a detecting unit that is configured to detect an object that exists in front of the vehicle;
a lighting controlling unit that controls that the headlight of the vehicle, the lighting controlling unit turning on the headlight when a certain condition is satisfied, the lighting controlling unit operating the headlight in a low beam mode when the detecting unit detects the object while the headlight is on, the lighting controlling unit operating the headlight in a high beam mode when the detecting unit does not detect the object while the headlight is on; and
a display controlling unit that causes the display device to display the image captured by the night vision camera when the object exists in front of the vehicle.

2. The vision assist apparatus according to claim 1, wherein:
when the detecting unit detects the object, the display controlling unit assumes that the object exists in front of the vehicle and causes the display device to display the image captured by the night vision camera.

3. The vision assist apparatus according to claim 1, wherein:
when the lighting controlling unit operates the headlight in the low beam mode, the display controlling unit assumes that the object exists in front of the vehicle and causes the display device to display the image captured by the night vision camera.

4. The vision assist apparatus according to claim 1, the apparatus further comprising.
an operation unit that is configured to output an operation signal indicative of a turning on or off of the headlight in response to an operation by a user, wherein the lighting controlling unit turns on the headlight when the operation unit outputs the operation signal indicative of the turning on.

5. The vision assist apparatus according to claim 1, the apparatus further comprising:
a surrounding light sensing unit that detects a luminosity of a surrounding of the vehicle, wherein the lighting controlling unit turns on the headlight when the luminosity of the surrounding of the vehicle indicates equal to or less than a certain value.

6. The vision assist apparatus according to claim 1, wherein:
the display device either displays the image captured by the night vision camera in a part of a windshield of the vehicle correspondingly to the vision of the driver, or applies and displays the image in a display portion that is provided between the windshield and the driver.

7. The vision assist apparatus according to claim 1 wherein:
the detecting unit detects at least one of a person and another vehicle as the object that exists in front of the vehicle.
